(19) United States
(12) Patent Application Publication
(10) Pub. No.: US 2019/0217574 A1
(43) Pub. Date: Jul. 18, 2019

(54) Bonding Article

(71) Applicant: Hitachi Chemical Company, Ltd., Tokyo (JP)

(72) Inventors: Takashi NAITO, Tokyo (JP); Shinichi TACHIZONO, Tokyo (JP); Kei YOSHIMURA, Tokyo (JP); Yuji HASHIBA, Tokyo (JP); Taigo ONODERA, Tokyo (JP); Tatsuya MIYAKE, Tokyo (JP); Akitoyo KONNO, Tokyo (JP)

(21) Appl. No.: 16/248,085

(22) Filed: Jan. 15, 2019

(30) Foreign Application Priority Data
Jan. 16, 2018 (JP) 2018-004733

(51) Int. Cl. B32B 7/025; B32B 7/12; B32B 17/10; B23K 35/36; C09J 1/00

(52) U.S. Cl. CPC B32B 7/025; B32B 7/12; B32B 17/10036; B32B 17/10119; B32B 17/10871; B23K 35/3601; C09J 2400/14; B32B 2307/206; B32B 2264/107; B32B 2264/105; B32B 2405/00; C09J 2203/326; C09J 1/00

(57) ABSTRACT

There is provided a bonding article comprising: an electrical insulating substrate; a first adhesion layer laminated on one surface of the electrical insulating substrate; and a second adhesion layer laminated on the other surface of the electrical insulating substrate. Both the first adhesion layer and the second adhesion layer include a low-melting-point lead-free glass containing vanadium oxide and tellurium oxide as chemical constituents and having a softening point of 360° C. or lower. And, when contours of the first adhesion layer, the electrical insulating substrate, and the second adhesion layer are projected parallel to one another along the lamination direction, the contour of the first adhesion layer is located inside the contour of the second adhesion layer.

### CLAIM OF PRIORITY

The present application claims priority from Japanese patent application serial no. 2018-004733 filed on Jan. 16, 2018, the content of which is hereby incorporated by reference into this application.

### FIELD OF THE INVENTION

The present invention relates to low-temperature bonding techniques and particularly to a bonding article suitable for low-temperature bonding of portions that require electrical insulation.

### DESCRIPTION OF RELATED ART

One of the key technologies in electronic components (e.g., semiconductor sensors, microelectromechanical system (MEMS) devices, quartz crystal oscillators, and ultrasonic probes) is a low-temperature bonding technique that enables the secure bonding of various different materials at relatively low temperature (e.g., 400° C. or lower). Currently, low-melting-point solders, low-melting-point glass frits, resin adhesives, etc. are normally used as bonding articles for low-temperature bonding.

Since electrically-conductive solders cannot be used for the bonding of portions for which electrical insulation is required, non-conductive low-melting-point glass frits or resin adhesives are usually used. Resin adhesives are more advantageous than low-melting-point glass frits in terms of low-temperature bonding. By contrast, when heat resistance, chemical stability, and bonding durability are required for a joint, low-melting-point glass frits are more advantageous than resin adhesives.

Conventionally, a low-melting-point lead glass that enables bonding at around 400° C. has been widely used to make low-melting-point glass frits. However, in the electrical and electronic equipment industries, the recent green procurement and green design trend makes the use of low-melting-point lead glass problematic because it contains a large amount of lead constituent which is one of prohibited substances as designated by the RoHS Directive (Restriction of Hazardous Substances Directive of EU on the restriction of the use of certain hazardous substances in electrical and electronic equipment).

In contrast to that, a low-melting-point lead-free glass has been developed that enables bonding at a temperature equivalent to or lower than the temperature applied to the bonding that uses conventional low-melting-point lead glasses. For example, JP 2013-032255 A (US 2014/0145122 A1) discloses a lead-free glass composition comprising 10 to 60 mass % of Ag₂O, 5 to 65 mass % of V₂O₅, and 15 to 50 mass % of TeO₂ when the components are represented by oxides, in which the total content ratio of Ag₂O, V₂O₃ and TeO₂ is 75 mass % or more and less than 100 mass %, and further comprising one or more kind among P₂O₅, BaO, K₂O, WO₃, Fe₂O₃, MnO₂, Sb₂O₃ and ZnO as a remnant by more than 0 mass % and 25 mass % or less. A low-melting-point lead-free glass described in JP 2013-32255 A (US 2014/0145122 A1) has an advantage of having a softening point of 320° C. or lower; however, a disadvantage is that it is electrically semiconductive and therefore not always suitable for the bonding of portions that require high electrical insulation.

On the other hand, WO 2017/051590 A1 discloses a bonding article comprising a substrate, a first layer being disposed on one surface of the substrate, and a second layer being disposed on the other surface of the substrate and including a phase having a thermal expansion coefficient that is different from that of a phase of the first layer, in which at least either the first layer or the second layer includes glass having a softening point of 400° C. or lower. The document also discloses that electrically insulating materials, such as a resin film and a glass film, can be used as the substrate.

The bonding article described in WO 2017/051590 A1 is expected to be suitable for low-temperature bonding of portions that require electrical insulation. However, when the present inventors carried out various experiments on low-temperature bonding of portions that require electrical insulation by using the bonding article described in WO 2017/051590 A1, contrary to expectations, electrical insulation failures sometimes occurred.

The inventors believe that this is because the bonding article described in WO 2017/051590 A1 is basically intended for use to mitigate thermal stress occurring in the joint portion (to prevent peeling and damage caused by the thermal stress) when bonding different kinds of materials having significantly different linear expansion coefficients with each other, and that ensuring the electrical insulation properties was not taken into consideration. In other words, further technological improvement was considered necessary in order to achieve low-temperature bonding that enables required electrical insulation properties in addition to satisfying the requirements of heat resistance, chemical stability, and bonding durability in joints.

### SUMMARY OF THE INVENTION

In view of the foregoing, it is an objective of the present invention to provide a bonding article which utilizes a low-melting-point lead-free glass frit and is suitable for low-temperature bonding of portions that require electrical insulation.

According to one aspect of the invention, there is provided a bonding article comprising: an electrical insulating substrate; a first adhesion layer laminated on one surface of the electrical insulating substrate; and a second adhesion layer laminated on the other surface of the electrical insulating substrate. Both the first adhesion layer and the second adhesion layer include a low-melting-point lead-free glass containing vanadium oxide and tellurium oxide as chemical constituents and having a softening point of 360° C. or lower. And, when contours of the first adhesion layer, the electrical insulating substrate, and the second adhesion layer are projected parallel to one another along the lamination direction, the contour of the first adhesion layer is located inside the contour of the second adhesion layer.

In the above aspect of a bonding article of the invention, the following modifications and changes can be made.

(i) An area of a bonding surface of the first adhesion layer may be within a range from 49% to 95% of an area of a bonding surface of the second adhesion layer.

(ii) The area of the bonding surface of the first adhesion layer may be within a range from 64% to 93% of the area of the bonding surface of the second adhesion layer.

(iii) An average thickness of the first adhesion layer and the second adhesion layer may be within a range from 7 μm to 40 μm each.

(iv) The contour of the second adhesion layer may be located inside the contour of the electrical insulating substrate.

(v) The first adhesion layer may be divided into a plurality of first adhesion pads.

(vi) The second adhesion layer may be divided into a plurality of second adhesion pads.

(vii) The low-melting-point lead-free glass may further contain at least one of tungsten oxide (WO₃), barium oxide (BaO), potassium oxide (K₂O), and phosphorus oxide (P₂O₅) as the chemical constituent(s).

(viii) The low-melting-point lead-free glass may further contain at least one of aluminum oxide (Al₂O₃), ferric oxide (Fe₂O₃), yttrium oxide (Y₂O₃), and lanthanum oxide (La₂O₃) as the chemical constituent(s).

(ix) The low-melting-point lead-free glass may further contain silver oxide (Ag₂O) as the chemical constituent.

(x) At least one of the first adhesion layer and the second adhesion layer may contain filler particles made of a ceramic or a metal.

(xi) The electrical insulating substrate may be a resin substrate.

(xii) The resin substrate may be made of a polyimide resin, a polyamide-imide resin, an epoxy resin, a phenoxy resin, or a silicon resin.

(xiii) The electrical insulating substrate may contain filler particles made of a ceramic.

### Advantages of the Invention

According to the present invention, there can be provided a bonding article that utilizes a low-melting-point lead-free glass frit and is suitable for low-temperature bonding of portions that require electrical insulation.

### BRIEF DESCRIPTION OF THE DRAWINGS

FIG. 1 is schematic illustrations showing a perspective view and a cross-sectional view of an example of a bonding article according to a first embodiment;

FIG. 2 is schematic illustrations showing a perspective view and a cross-sectional view of another example of the bonding article according to the first embodiment;

FIG. 3 is schematic illustrations showing a perspective view and a cross-sectional view of an example of a bonding article according to a second embodiment;

FIG. 4 is schematic illustrations showing a perspective view and a cross-sectional view of an example of a bonding article according to a third embodiment;

FIG. 5 is schematic illustrations showing a perspective view and a cross-sectional view of an example of a bonding article according to a fourth embodiment;

FIG. 6 is an exemplary chart obtained in a temperature rise process of the differential thermal analysis concerning a typical low-melting-point lead-free glass used for the present invention;

FIG. 7 is schematic illustrations showing a perspective view and a cross-sectional view of an exemplary process to bond members to be joined by using a bonding article according to the present invention; and

FIG. 8 is schematic illustrations showing a perspective view and a cross-sectional view of an exemplary process to bond members to be joined by using a bonding article according to the present invention.

### DETAILED DESCRIPTION OF THE PREFERRED EMBODIMENTS

(Basic concept of the invention) As stated before, when the inventors conducted various experiments in low-temperature bonding of portions that require electrical insulation by using the bonding article described in WO 2017/051590 A1, electrical insulation failures occurred in some cases. The inventors surveyed and studied the experimental results in detail to find out the cause of the problems.

As a result, it was found that slight difference in bonding conditions (e.g., combination of the softening point temperature of low-melting-point lead-free glass, the bonding temperature, and the bonding surface pressure) sometimes causes direct contact between the first adhesion layer and the second adhesion layer at the outer edge of the substrate, which results in an occurrence of an electrical insulation failure (electric short circuit).

Also, the inventors conducted further experiments by making the outer edges of the first and second adhesion layers sufficiently smaller than the outer edge of the substrate (i.e., sufficient clearance was created between the outer edges of the first and second adhesion layers and the outer edge of the substrate) in order to prevent electric short circuits between the first adhesion layer and the second adhesion layer at the substrate's outer edge. Consequently, it was discovered that electrical insulation failures or malfunctions are prone to occur due to insufficient bonding strength, bonding durability, or other factors (e.g., the accumulation over time of water and dust in the clearance).

Accordingly, the inventors carried out intensive studies of the techniques to prevent the aforementioned malfunction. As a result, the inventors found out that the problems (malfunctions) mentioned above can be solved by configuring a bonding article where a first adhesion layer, electrical insulating substrate, and a second adhesion layer are laminated in that order, in such a way that, when the respective contours of the first adhesion layer, the electrical insulating substrate, and the second adhesion layer are projected parallel to one another along the lamination direction, the contour of the first adhesion layer is located inside the contour of the second adhesion layer. The present invention is based on this concept.

Preferred embodiments of the invention will be described hereinafter with reference to the accompanying drawings. However, it should be noted that the invention is not limited to the specific embodiments described below, and various combinations with known art and modifications based on known art are possible without departing from the spirit and scope of the invention where appropriate. Meanwhile, the same sign is provided for the same member and portion, and description of overlap will be omitted.

### First Embodiment

(Structure of Bonding Article)

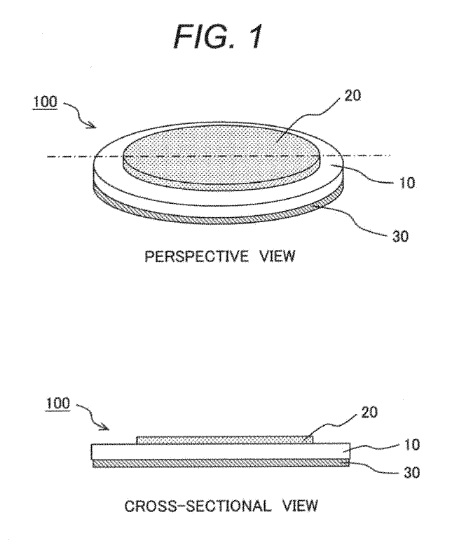

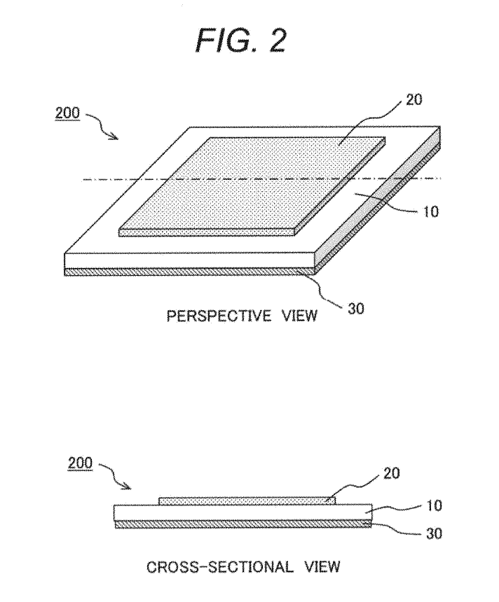

FIG. 1 is schematic illustrations showing a perspective view and a cross-sectional view of an example of a bonding article according to a first embodiment. FIG. 2 is schematic illustrations showing a perspective view and a cross-sectional view of another example of the bonding article according to the first embodiment.

As shown in FIGS. 1 and 2, each of the bonding articles 100 and 200 according to the first embodiment is configured so that a first adhesion layer 20 and a second adhesion layer 30 are laminated respectively on both surfaces of the electrical insulating substrate 10, and when contours of the first adhesion layer 20 and the second adhesion layer 30 are projected parallel to each other along the lamination direction, the contour of the first adhesion layer 20 is located inside the contour of the second adhesion layer 30. Also, the first adhesion layer 20 and the second adhesion layer 30 include a low-melting-point lead-free glass containing vanadium oxide (V₂O₅) and tellurium oxide (TeO₂) as chemical constituents and having a softening point of 360° C. or lower.

Meanwhile, in FIGS. 1 and 2, the electrical insulating substrate 10, the first adhesion layer 20, and the second adhesion layer 30 are illustrated as a circular shape or a quadrangular shape. However, the invention is not limited to those shapes, but any shape can be adopted.

In order to prevent electric short circuits between the first adhesion layer 20 and the second adhesion layer 30 at the outer edge of the electrical insulating substrate 10 when members to be joined are bonded by interposing the bonding article 100 or 200 therebetween, it is preferable that the area of bonding surface of the first adhesion layer 20 be 95% or less of the area of bonding surface of the second adhesion layer; and more preferably 93% or less. If the area of the bonding surface of the first adhesion layer 20 is more than 95% of the area of the bonding surface of the second adhesion layer, electric short circuits between the first adhesion layer 20 and the second adhesion layer 30 tend to easily occur.

Furthermore, in order to ensure bonding strength and bonding durability when the members to be joined are bonded by interposing the bonding article 100 or 200 therebetween, it is preferable that the area of the bonding surface of the first adhesion layer 20 be 49% or more of the area of the bonding surface of the second adhesion layer; and more preferably 64% or more. If the area of the bonding surface of the first adhesion layer 20 is less than 49% of the area of the bonding surface of the second adhesion layer, bonding strength and bonding durability are prone to deteriorate.

The contour of the second adhesion layer 30 and the contour of the electrical insulating substrate 10 can be the same (the same area). However, to reliably prevent electric short circuits between the first adhesion layer 20 and the second adhesion layer 30 when using the bonding article, it is more preferable that the contour of the second adhesion layer 30 be located inside the contour of the electrical insulating substrate 10. For example, it is preferable that the area of the bonding surface of the second adhesion layer 30 be 90% or more but less than 100% of the area of the electrical insulating substrate 10; and more preferably 95% or more but 99% or less.

In addition, it is preferable that the average thickness of the first adhesion layer 20 and the second adhesion layer 30 be respectively between 7 μm and 40 μm; and more preferably between 8 μm and 35 μm; and further preferably between 10 μm and 30 μm. If the average thickness of the first adhesion layer 20 and the second adhesion layer 30 becomes less than 7 μm, the bonding durability is prone to deteriorate. If the average thickness of the first adhesion layer 20 and the second adhesion layer 30 is more than 40 μm, the bonding durability easily deteriorates and electric short circuits easily occur.

(Configuration of First Adhesion Layer and Second Adhesion Layer)

As stated before, the first adhesion layer 20 and the second adhesion layer 30 include a low-melting-point lead-free glass containing V₂O₃ and TeO₂ as chemical components and having a softening point of 360° C. or lower. It is possible to perform low-temperature bonding at a temperature of 400° C. or lower by controlling the chemical composition so that the softening point of the low-melting-point lead-free glass becomes 360° C. or lower.

When in the softening and fluidizing condition, the low-melting-point lead-free glass exhibits good wettability as to various materials (e.g., metal materials, ceramic materials, and resin materials). This means that the low-melting-point lead-free glass has good adhesion properties as to various materials. This is considered because in the softening and fluidizing condition, the V₂O₃ constituent can reduce and remove the oxide layer that is likely to be present on the surface of the members to be joined.

It is preferable that the low-melting-point lead-free glass further contains one or more constituents selected from WO₃, BaO, K₂O, and P₂O₃ as chemical component(s). Those chemical components have an additional advantage to accelerate the vitrification of the low-melting-point lead-free glass. This means that as the softening and fluidizing properties increase due to vitrification, the additional advantage that can contribute to the improvement of adhesion properties will be obtained.

It is preferable that the low-melting-point lead-free glass further contains one or more constituents selected from Al₂O₃, Fe₂O₃, Y₂O₃ and La₂O₃. Those chemical components have another additional advantage to suppress crystallization of the low-melting-point lead-free glass. This means that as the softening and fluidizing stability of the glass increases, the additional advantage that can contribute to the improvement of adhesion properties will be obtained.

It is most preferable that the low-melting-point lead-free glass further contains Ag₂O as a chemical constituent. This chemical component has still another additional advantage to lower the characteristic temperature (e.g., glass transition point, deformation point, and softening point) of the low-melting-point lead-free glass. This means that as the glass can be softening and fluidizing at lower temperature, the additional advantage that can contribute to the lowering of the bonding temperature will be obtained.

When bonding different kinds of materials having significantly different linear expansion coefficients, it is necessary to take into consideration the relaxation of thermal stress that could possibly occur in the joint portion. Therefore, as necessary, it is preferable that the first adhesion layer 20 and the second adhesion layer 30 contain filler particles to adjust linear expansion coefficients.

The filler particles are not particularly limited and conventional particles (e.g., filler particles composed of ceramics or metals) can be used appropriately. For example, when the linear expansion coefficient of the first adhesion layer 20 and the second adhesion layer 30 is desirably made smaller than that of the low-melting-point lead-free glass, it is effective to include phosphorus zirconium tungstate (Zr₂(WO₄) (PO₄)₂) particles having a negative linear expansion coefficient as filler particles.

(Configuration of Electrical Insulating Substrate)

The electrical insulating substrate 10 is an essential member to ensure the electrical insulation properties in the joint created by using the bonding article according to the invention. Material of the electrical insulating substrate 10 is not particularly limited, and conventional materials (e.g., ceramic materials, and resin materials) can be used appropriately according to characteristics (e.g., dielectric strength voltage, heat resistance, durability, stiffness, and flexibility) required for the joint.

For example, when the required heat resistance level is around 300° C., it is preferable to use an electrical insulating substrate 10 made of resin material to ensure thermal stress buffering properties and flexibility. As resin materials, a polyimide resin, a polyamide-imide resin, an epoxy resin, a phenoxy resin, and a silicon resin can be preferably used.

When adjustment of stiffness and thermal expansion is required for the electrical insulating substrate 10 made of resin material, a ceramic filler may be included in the electrical insulating substrate 10. By doing so, it is possible to adjust Young's modulus or a linear expansion coefficient of the electrical insulating substrate 10.

(Bonding Article Production Method)

A method for producing a bonding article according to the invention is not particularly limited as long as a bonding article of desired structure (e.g., refer to FIGS. 1 and 2) can be obtained, and conventional production processes can be utilized appropriately. Hereinafter, an example of a bonding article production method will be briefly described.

First, a low-melting-point lead-free glass is prepared to be used for the first adhesion layer 20 and the second adhesion layer 30. A method for preparing the low-melting-point lead-free glass is not particularly limited, and conventional methods can be utilized appropriately. For example, by weighing, mixing, heating (melting), cooling and pulverizing a predetermined amount of glass raw materials, it is possible to prepare desired low-melting-point lead-free glass powder. A substrate to be used as an electrical insulating substrate 10 is separately prepared.

When laminating the first adhesion layer 20 and the second adhesion layer 30 respectively on both surfaces of the electrical insulating substrate 10, in order to ensure workability, it is preferable that an adhesion layer forming paste which includes the low-melting-point lead-free glass powder be prepared. The adhesion layer forming paste can be prepared by mixing and kneading the low-melting-point lead-free glass powder, a resin binder (e.g., ethyl cellulose, cellulose nitrate, or modified polyphenylene ether), and a solvent (e.g., butyl carbitol acetate, α-terpineol, or Isobornyl cyclohexanol). As necessary, filler particles are also mixed and kneaded together to adjust the linear expansion coefficient.

Next, the adhesion layer forming paste for the first adhesion layer or the second adhesion layer is applied to one surface of the electrical insulating substrate 10, and then the laminated layer is dried to remove the solvent; thus, lamination of a dry coating film is formed. A method for applying the adhesion layer forming paste is not particularly limited, conventional methods (e.g., screen printing technique or doctor blade method) can be applied appropriately.

When using a screen printing technique or a doctor blade method to form the lamination of dry coating film, in order to facilitate mass production, it is preferable that the paste be applied to one surface of one entire long and wide electrical insulating substrate 10, and at the final stage of production, the paste-applied long and wide electrical insulating substrate 10 is divided into many pieces to form individual bonding articles 100 or 200.

Next, the adhesion layer forming paste for the other adhesion layer is applied to the other surface of the electrical insulating substrate 10, and then the laminated layer is dried to remove the solvent; thus, lamination of the other dry coating film is formed. When the contours are projected parallel to each other along the lamination direction to form lamination of the other dry coating film, the lamination should be constructed so that the contour of the dry coating film for the first adhesion layer is located inside the contour of the dry coating film for the second adhesion layer.

Then, the entire article (i.e., the dry coating films have been laminated on both surfaces of the electrical insulating substrate 10) is calcined in the atmosphere to form each dry coating film into the first adhesion layer 20 and the second adhesion layer 30. For an appropriate calcination condition for this process, thermal treatment having a two-stage temperature profile is preferable. Specifically, preferable thermal treatment is so that a resin binder included in the dry coating film is pyrolyzed at the first-stage temperature rise, and then at the second-stage temperature rise, the temperature is increased to a temperature higher than the softening point of the low-melting-point lead-free glass to bond together the first adhesion layer 20, the electrical insulating substrate 10, and the second adhesion layer 30.

Subsequently, the long and wide electrical insulating substrate 10 on which many individual bonding articles have been formed is cut and divided into many individual bonding articles 100 or 200. A cutting method is not particularly limited, conventional methods (e.g., dicer, cutter, laser beam machining, and ultrasonic machining) can be utilized appropriately.

(Bonding Article Use Method)

A method of using a bonding article 100 or 200 according to the invention is not particularly limited. For example, the bonding article 100 or 200 is placed between two members to be joined and can simply be heated to bond at a temperature higher than the softening point (e.g., temperature 5 to 50° C. higher than the softening point) of the low-melting-point lead-free glass contained in the first adhesion layer 20 and the second adhesion layer 30. As necessary, it is possible to perform heating to bond the members while applying pressure stress to the two members.

### Second Embodiment

A second embodiment has a bonding article structure different from that of the first embodiment; however, other parts are the same and the advantages are the same.

Therefore, only the different points from the first embodiment will be described.

(Structure of Bonding Article)

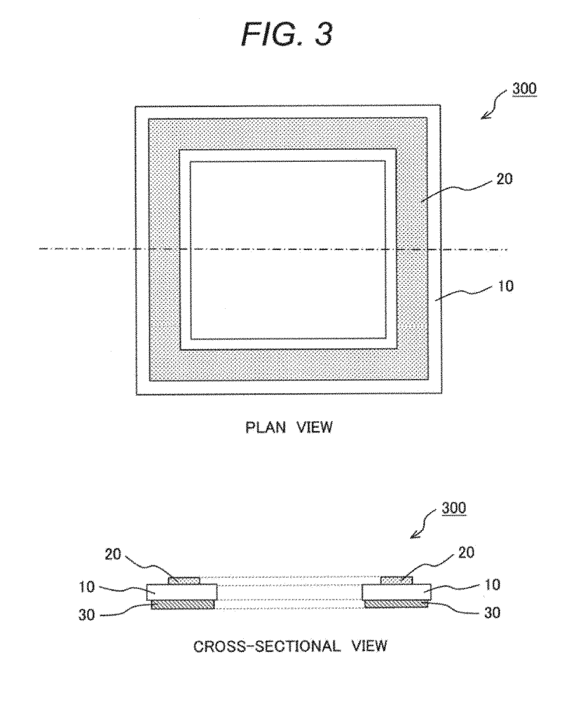

FIG. 3 is schematic illustrations showing a perspective view and a cross-sectional view of an example of a bonding article according to a second embodiment. As shown in FIG. 3, in a bonding article 300, the electrical insulating substrate 10, the first adhesion layer 20 and the second adhesion layer 30 are of the ring shape; the first adhesion layer 20 and the second adhesion layer 30 are laminated on both surfaces of the electrical insulating substrate 10; and when contours of the first adhesion layer 20 and the second adhesion layer 30 are projected parallel to each other along the lamination direction, the contour of the first adhesion layer 20 is located inside the contour of the second adhesion layer 30.

When two members to be joined are bonded by interposing a bonding article 300 therebetween, in order to reliably prevent electric short circuits between the first adhesion layer 20 and the second adhesion layer 30, it is preferable that the contour of the second adhesion layer 30 be located inside the contour of the electrical insulating substrate 10.

In FIG. 3, the electrical insulating substrate 10, the first adhesion layer 20 and the second adhesion layer 30 are illustrated in a quadrangular ring shape; however, this embodiment is not limited to that shape, but any ring shape can be adopted.

### Third Embodiment

A third embodiment has a bonding article structure different from that of the first embodiment; however, other parts are the same and the advantages are similar. Therefore, only the different points from the first embodiment will be described.

(Structure of Bonding Article)

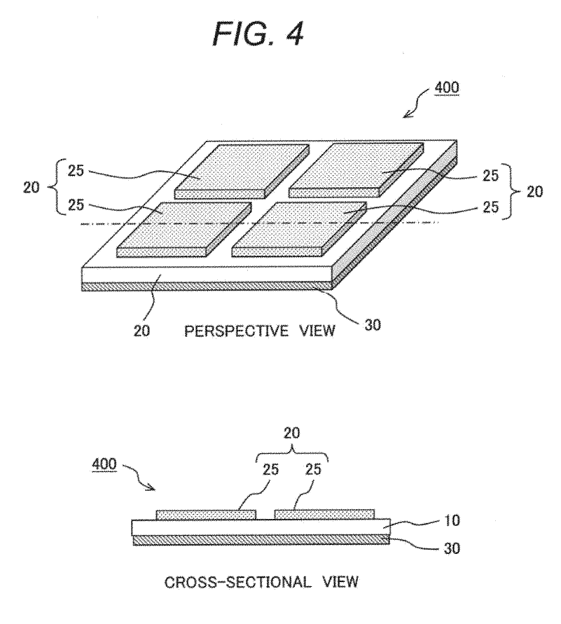

FIG. 4 is schematic illustrations showing a perspective view and a cross-sectional view of an example of a bonding article according to a third embodiment. As shown in FIG. 4, a bonding article 400 has almost the same structure as the bonding article 200 according to the first embodiment, and additionally, the first adhesion layer 20 is divided into two or more first adhesion pads 25.

In order to reliably prevent electric short circuits between the first adhesion pads 25 and the second adhesion layer 30 when two members to be joined are bonded by interposing a bonding article 400 therebetween, it is preferable that the contour of the second adhesion layer 30 be located inside the contour of the electrical insulating substrate 10.

In FIG. 4, the electrical insulating substrate 10, the first adhesion pads 25, and the second adhesion layer 30 are illustrated in a quadrangular shape; however, this embodiment is not limited to that shape, and any shape can be adopted.

### Fourth Embodiment

A fourth embodiment has a bonding article structure different from that of the third embodiment; however, other parts are the same, and the advantages are the same as those of the first embodiment. Therefore, only the different points from the third embodiment will be described.

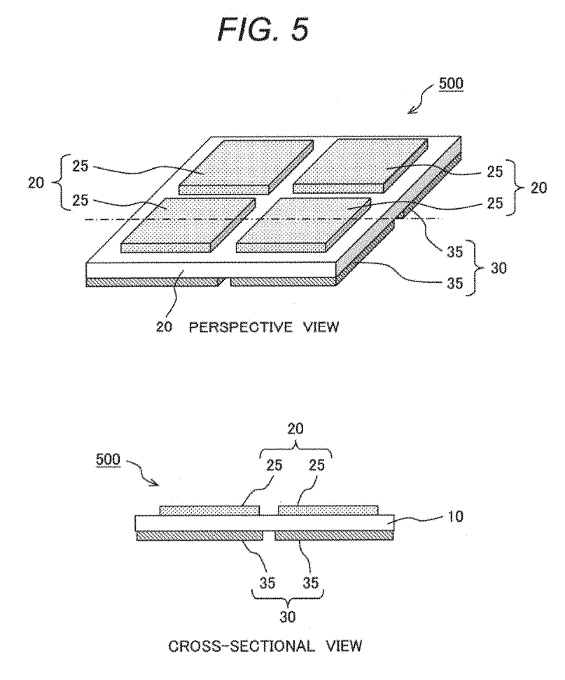

(Structure of Bonding Article) FIG. 5 is schematic illustrations showing a perspective view and a cross-sectional view of an example of a bonding article according to a fourth embodiment. As shown in FIG. 5, a bonding article 500 has almost the same structure as the bonding article 400 according to the third embodiment, and additionally, the second adhesion layer 30 is divided into two or more second adhesion pads 35. Furthermore, when contours of the first adhesion pads 25 and the second adhesion pads 35 are projected parallel to one another along the lamination direction, the contours of the first adhesion pads 25 are located inside the contours of the second adhesion pads 35.

In order to reliably prevent electric short circuits between the first adhesion pads 25 and the second adhesion pads 35 when two members to be joined are bonded by interposing a bonding article 500 therebetween, it is preferable that the contours of the second adhesion pads 35 be located inside the contour of the electrical insulating substrate 10.

In FIG. 5, the electrical insulating substrate 10, the first adhesion pads 25 and the second adhesion pads 35 are illustrated in a quadrangular shape; however, this embodiment is not limited to that shape, and any shape can be adopted.

### EXAMPLES

Hereinafter, the present invention will be more specifically described based on specific experimental examples. However, the invention is not intended to be limited to those experimental examples, but includes their variations.

### Experimental 1

(Production of Low-Melting-Point Lead-Free Glass)

Low-melting-point lead-free glasses (G-01 to G-42) having nominal compositions, indicated later in Tables 1 and 2, were produced. The nominal compositions indicated in those tables are expressed by a molar ratio according to the oxide conversion of each constituent. As a starting material, vanadium oxide powder (purity: 99.9%) made by Shinko Chemical Co., Ltd. was used for the V-source. Oxide powders (purity: 99.9%) made by Kojundo Chemical Laboratory Co., Ltd. were used for the Te-source, Ag-source, W-source, Al-source, Fe-source, Y-source, La-source, and Zn-source. Carbonate powders (purity: 99.9%) made by Kojundo Chemical Laboratory Co., Ltd. were used for the Ba-source and K-source. As expected from the purity level of the starting materials, each of the low-melting-point lead-free glasses prepared in the invention contains to some extent unavoidable impurities.

TABLE 1
Nominal compositions of low-melting-point lead-free glasses (G-01 to G-20).

| Glass | Nominal composition of low-melting-point lead-free glass (mol %) | | | | | | | | | | | |
|---|---|---|---|---|---|---|---|---|---|---|---|---|
| No. | V₂O₅ | TeO₂ | Ag₂O | WO₃ | BaO | K₂O | P₂O₅ | Al₂O₃ | Fe₂O₃ | Y₂O₃ | La₂O₃ | ZnO |
| G-01 | 43.1 | 31.3 | — | — | — | — | 15.2 | — | 10.4 | — | — | — |
| G-02 | 37.8 | 32.3 | — | 7.5 | 22.4 | — | — | — | — | — | — | — |
| G-03 | 37.7 | 32.1 | — | 7.4 | 17.0 | — | 5.8 | — | — | — | — | — |
| G-04 | 34.4 | 31.0 | — | 7.2 | 12.0 | 8.7 | 6.7 | — | — | — | — | — |
| G-05 | 37.9 | 37.8 | — | 7.4 | 16.9 | — | — | — | — | — | — | — |
| G-06 | 34.7 | 32.2 | — | 7.4 | 25.7 | — | — | — | — | — | — | — |
| G-07 | 42.1 | 29.2 | — | 5.7 | — | — | 10.6 | — | 6.3 | — | — | 6.1 |
| G-08 | 43.5 | 31.6 | — | 3.6 | — | — | 11.8 | — | 7.4 | — | — | 2.1 |
| G-09 | 38.1 | 36.9 | — | 7.5 | 17.0 | — | — | — | — | — | 0.5 | — |
| G-10 | 37.6 | 36.4 | — | 5.9 | 17.8 | 1.8 | — | — | — | — | 0.5 | — |
| G-11 | 27.0 | 40.0 | 12.0 | 9.0 | 5.0 | 3.0 | — | 1.0 | 3.0 | — | — | — |
| G-12 | 25.0 | 40.0 | 15.0 | 5.0 | 10.0 | 5.0 | — | — | — | — | — | — |
| G-13 | 25.0 | 40.0 | 15.0 | 9.0 | 4.0 | 3.0 | — | 1.0 | 3.0 | — | — | — |
| G-14 | 22.0 | 40.0 | 15.0 | 9.0 | 6.0 | 5.0 | — | — | — | — | 3.0 | — |
| G-15 | 25.0 | 40.0 | 17.0 | 10.0 | 3.0 | 3.0 | — | — | — | — | 2.0 | — |
| G-16 | 24.0 | 40.0 | 17.0 | 9.0 | 4.0 | 3.0 | — | — | 3.0 | — | — | — |
| G-17 | 24.0 | 40.0 | 17.0 | 9.0 | 4.0 | 3.0 | — | 3.0 | — | — | — | — |
| G-18 | 23.0 | 40.0 | 17.0 | 9.0 | 4.0 | 3.0 | — | 1.0 | 3.0 | — | — | — |
| G-19 | 22.0 | 40.0 | 22.0 | 7.0 | 3.0 | 3.0 | — | 1.0 | 2.0 | — | — | — |
| G-20 | 20.0 | 41.0 | 23.0 | 7.0 | — | 5.0 | — | 1.0 | 3.0 | — | — | — |

Symbol “—” indicates that the constituent was not intentionally mixed.

TABLE 2
Nominal compositions of low-melting-point lead-free glasses (G-21 to G-42).

| Glass | Nominal composition of low-melting-point lead-free glass (mol %) | | | | | | | | | | | |
|---|---|---|---|---|---|---|---|---|---|---|---|---|
| No. | V₂O₅ | TeO₂ | Ag₂O | WO₃ | BaO | K₂O | P₂O₅ | Al₂O₃ | Fe₂O₃ | Y₂O₃ | La₂O₃ | ZnO |
| G-21 | 17.6 | 37.7 | 30.8 | 4.9 | 3.2 | — | 5.8 | — | — | — | — | — |
| G-22 | 20.0 | 40.0 | 30.0 | 5.0 | 5.0 | — | — | — | — | — | — | — |
| G-23 | 20.0 | 37.5 | 35.0 | 2.0 | 5.0 | — | — | — | — | — | 0.5 | — |
| G-24 | 20.5 | 39.0 | 33.0 | 5.0 | — | — | — | — | — | — | 2.5 | — |
| G-25 | 20.3 | 42.8 | 23.9 | 4.8 | 7.8 | — | — | — | — | — | 0.3 | — |
| G-26 | 20.0 | 39.5 | 30.0 | 5.0 | 5.0 | — | — | — | — | — | 0.5 | — |
| G-27 | 20.0 | 40.0 | 30.0 | 7.0 | — | — | — | — | — | — | 3.0 | — |
| G-28 | 21.0 | 41.0 | 31.0 | 5.0 | — | — | — | — | — | — | 2.0 | — |
| G-29 | 20.5 | 39.0 | 33.0 | 5.0 | — | — | — | — | — | 0.5 | 2.0 | — |
| G-30 | 21.0 | 38.0 | 33.0 | 5.0 | — | — | — | — | — | 1.0 | 2.0 | — |
| G-31 | 21.0 | 38.0 | 31.0 | 5.0 | — | — | — | — | — | 1.0 | 2.0 | 2.0 |
| G-32 | 25.0 | 40.0 | 25.0 | 5.0 | — | — | — | — | — | 1.0 | 2.0 | 2.0 |
| G-33 | 22.0 | 40.0 | 20.0 | 5.0 | 5.0 | 6.0 | — | — | — | — | 2.0 | — |
| G-34 | 21.0 | 39.0 | 20.0 | 6.0 | 8.0 | 5.0 | — | — | — | — | 1.0 | — |
| G-35 | 21.0 | 40.0 | 25.0 | 7.0 | — | 3.0 | — | 1.0 | 3.0 | — | — | — |
| G-36 | 21.0 | 42.0 | 23.0 | 5.0 | — | 5.0 | — | — | 3.0 | — | 1.0 | — |
| G-37 | 21.0 | 40.0 | 25.0 | 5.0 | — | 5.0 | — | 0.5 | 3.0 | — | 0.5 | — |
| G-38 | 21.0 | 35.0 | 39.5 | 1.0 | 3.0 | — | — | — | — | — | 0.5 | — |
| G-39 | 21.0 | 35.0 | 40.0 | 3.0 | — | — | — | — | — | 0.5 | 0.5 | — |
| G-40 | 23.0 | 29.5 | 43.5 | 3.0 | — | — | — | — | — | 1.0 | — | — |
| G-41 | 22.5 | 28.0 | 45.0 | 1.0 | 3.0 | — | — | — | — | — | 0.5 | — |
| G-42 | 23.0 | 30.0 | 45.0 | 1.0 | — | — | — | — | — | — | 1.0 | — |

Symbol “—” indicates that the constituent was not intentionally mixed.

The starting material powders were mixed to form the molar ratio indicated in Tables 1 and 2 and then put into a platinum or quartz crucible. The crucible containing the mixed raw material powders was placed in a glass-melting furnace and heated to melt the glass. The temperature was increased at a rate of 10° C. per minute, and the glass that was melting at a predetermined temperature (700 to 850° C.) was kept for one hour while the glass was stirred by an alumina rod. After that, the crucible was removed from the glass-melting furnace and the glass was casted into a stainless-steel mold which had been preheated to a temperature between 150° C. and 200° C. Next, the glass ingot was transferred to a strain-removing furnace that had been preheated to an appropriate temperature to remove strain, kept for one hour to remove strain, and then cooled to room temperature at a rate of 1° C. per minute. The strain-removed glass ingot was then pulverized. In this way, the low-melting-point lead-free glass powders each having a nominal composition indicated in the tables (median size: D50≤3 μm) were prepared.

Herein, each of the low-melting-point lead-free glasses G-01 to G-10 was melted at 850° C. using a platinum crucible; each of the low-melting-point lead-free glasses G-11 to G-37 was melted at 750° C. using a quartz crucible; and each of the low-melting-point lead-free glass G-38 to G-42 was melted at 700° C. using a quartz crucible. Furthermore, from the strain-removed glass ingots (non-powdered state), specimens to be measured for electrical resistivity were separately sampled.

### Experimental 2

(Investigations of Physical Characteristics of Low-Melting-Point Lead-Free Glasses)

Each of the low-melting-point lead-free glasses G-01 to G-42 prepared in experimental 1 was measured for various physical characteristics (i.e., characteristic temperatures, density, and linear expansion coefficient). The characteristic temperature was measured by the differential thermal analysis (DTA), and glass transition point T_{g}, deformation point M_{g}, and softening point Tₛ were measured. The DTA measurement was conducted so that the reference specimen (α-alumina) and the measurement specimen each having mass of 650 mg were measured in the atmosphere while temperature was increased at a rate of 5° C. per minute. The density measurement was conducted by the constant-volume expansion method. The linear expansion coefficient was measured in accordance with JIS R 3102. The results will be shown later in Tables 3 and 4.

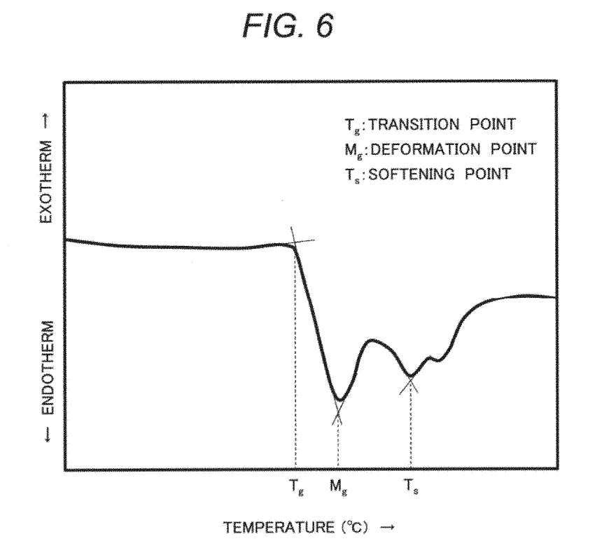

The characteristic temperatures of glass will be briefly explained. FIG. 6 is an exemplary chart (DTA curve) obtained in a temperature rise process of the differential thermal analysis (DTA) concerning a typical low-melting-point lead-free glass used for the invention. As shown in FIG. 6, the first endothermic peak start temperature is the glass transition point T_{g}, the endothermic peak temperature thereof is the deformation point M_{g}, the second endothermic peak temperature is the softening point Tₛ; and they are obtained by the tangent method. T_{g}, M_{g} and Tₛ are also defined by viscosity; T_{g} corresponds to the temperature that enables viscosity of 10^{13.3} poise, M_{g} corresponds to the temperature that enables viscosity of 10^{11.0} poise, and Tₛ corresponds to the temperature that enables viscosity of 10^{7.65} poise.

TABLE 3
Physical characteristics of low-melting-point lead-free glasses (G-01 to G-20).

| | | Characteristic temperature (° C.) | | | Linear expansion coefficient | |
|---|---|---|---|---|---|---|
| Glass | | Glass transition | Deformation | Softening | | Temperature |
| No. | Density | point T_{g} | point M_{g} | point Tₛ | (×10⁻⁷/° C.) | range (° C.) |
| G-01 | 3.58 | 294 | 319 | 358 | 102 | 30-250 |
| G-02 | 4.39 | 284 | 303 | 334 | 149 | |
| G-03 | 4.23 | 295 | 314 | 357 | 128 | |
| G-04 | 4.05 | 278 | 297 | 333 | 164 | |
| G-05 | 4.43 | 281 | 297 | 331 | 141 | |
| G-06 | 4.53 | 303 | 317 | 355 | 152 | |
| G-07 | 3.76 | 282 | 309 | 359 | 99 | |
| G-08 | 3.69 | 281 | 308 | 353 | 102 | |
| G-09 | 4.42 | 279 | 302 | 335 | 139 | |
| G-10 | 4.36 | 275 | 300 | 332 | 148 | |
| G-11 | 4.81 | 253 | 279 | 320 | 140 | 30-200 |
| G-12 | 5.01 | 221 | 241 | 282 | 145 | |
| G-13 | 4.98 | 249 | 273 | 313 | 144 | |
| G-14 | 5.04 | 237 | 265 | 307 | 148 | |
| G-15 | 5.13 | 233 | 257 | 295 | 156 | |
| G-16 | 5.08 | 238 | 264 | 304 | 161 | |
| G-17 | 5.04 | 236 | 261 | 303 | 155 | |
| G-18 | 5.06 | 245 | 271 | 313 | 158 | |
| G-19 | 5.20 | 222 | 245 | 284 | 161 | |
| G-20 | 5.25 | 222 | 243 | 282 | 166 | |

TABLE 4
Physical characteristics of low-melting-point lead-free glasses (G-21 to G-42).

| | | Characteristic temperature (° C.) | | | Linear expansion coefficient | |
|---|---|---|---|---|---|---|
| Glass | | Glass transition | Deformation | Softening | | Temperature |
| No. | Density | point T_{g} | point M_{g} | point Tₛ | (×10⁻⁷/° C.) | range (° C.) |
| G-21 | 5.52 | 207 | 225 | 263 | 178 | 30-150 |
| G-22 | 5.69 | 189 | 207 | 240 | 184 | |
| G-23 | 5.67 | 174 | 196 | 231 | 196 | |
| G-24 | 5.70 | 191 | 214 | 244 | 177 | |
| G-25 | 5.45 | 209 | 227 | 263 | 173 | |
| G-26 | 5.58 | 190 | 212 | 245 | 182 | |
| G-27 | 5.55 | 204 | 230 | 265 | 175 | |
| G-28 | 5.61 | 194 | 216 | 252 | 180 | |
| G-29 | 5.64 | 184 | 206 | 244 | 191 | |
| G-30 | 5.62 | 190 | 209 | 243 | 188 | |
| G-31 | 5.64 | 194 | 217 | 252 | 176 | |
| G-32 | 5.48 | 212 | 235 | 270 | 173 | |
| G-33 | 5.15 | 209 | 234 | 275 | 165 | |
| G-34 | 5.13 | 212 | 235 | 278 | 163 | |
| G-35 | 5.28 | 213 | 243 | 280 | 165 | |
| G-36 | 5.22 | 215 | 239 | 280 | 167 | |
| G-37 | 5.18 | 214 | 237 | 278 | 170 | |
| G-38 | 5.71 | 160 | 179 | 210 | 205 | 30-130 |
| G-39 | 5.73 | 161 | 176 | 209 | 198 | |
| G-40 | 5.75 | 158 | 175 | 204 | 202 | |
| G-41 | 5.78 | 147 | 165 | 193 | 210 | |
| G-42 | 5.81 | 148 | 161 | 190 | 208 | |

As shown in Tables 3 and 4, it is verified that the softening point Tₛ is 360° C. or lower in each of G-21 to G-42 specimens. Regarding density, as the contents of high-specific heavy constituents (e.g., Ag₂O and WO₃) become high, density of the low-melting-point lead-free glass tends to become high. Also, regarding the linear expansion coefficient, as the characteristic temperatures become lower, the linear expansion coefficient tends to increase.

Using the specimens for electrical resistivity measurement, the electrical resistivity was measured at room temperature in accordance with JIS K 6911. According to the results, the electrical resistivity of each of the low-melting-point lead-free glasses G-01 to G-42 prepared in experimental 1 was in a range between 10⁶ and 10¹⁰ Ωcm and tends to become lower with the increase in the contents of V₂O₃ and P₂O₃. When compared with the glass known as electrically insulating glass, such as soda-lime glass (electrical resistivity of 10¹² Ωcm), soda glass (electrical resistivity of 10¹³ Ωcm), borosilicate glass (electrical resistivity of 10¹⁴ Ωcm), and quartz glass (electrical resistivity of 10¹⁸ Ωcm), the low-melting-point lead-free glasses G-01 to G-42 have at least 2-digit lower electrical resistivity and are considered semiconductive.

### Experimental 3

(Production of Adhesion Layer Forming Paste)

Adhesion layer forming pastes were produced using the powders of low-melting-point lead-free glasses G-01 to G-42 prepared in experimental 1, filler particles F-01 to F-06 shown in Table 5, resin binders, and solvents. The blend ratio of the low-melting-point lead-free glass powder and the filler particles was adjusted so that the low-melting-point lead-free glass powder is 100 parts by volume and the filler particles are within a range from 0 to 40 parts by volume. Herein, the specific blend ratio of the filler particles will be described later in Tables 6 and 7.

TABLE 5
Physical characteristics of filler particles (F-01 to F-06).

| | | | Linear |
|---|---|---|---|
| | | | expansion |
| Filler | Material | Density | coefficient |
| particles No. | (chemical formula) | (g/cm³) | (×10⁻⁷/° C.) |
| F-01 | Phosphorus zirconium tungstate | 4.0 | −40 |
| | (Zr₂(WO₄)(PO₄)₂) | | |
| F-02 | Quartz glass | 2.2 | 5 |
| | (SiO₂) | | |
| F-03 | Aluminum oxide | 4.0 | 78 |
| | (Al₂O₃) | | |
| F-04 | Soda-lime glass | 2.5 | 88 |
| | (SiO₂—Na₂O—CaO system glass) | | |
| F-05 | Silver | 10.5 | 197 |
| | (Ag) | | |
| F-06 | Tin | 7.3 | 199 |
| | (Sn) | | |

Furthermore, regarding resin binders and solvents, an ethyl cellulose resin binder and a butyl carbitol acetate solvent were used along with the powders of the low-melting-point lead-free glasses G-01 to G-10. To be used with the powders of the melting-point lead-free glasses G-11 to G-37, an aliphatic polycarbonate resin binder and a propylene carbonate solvent were used. To be used with the powders of the melting-point lead-free glasses G-38 to G-42, no resin binder was used, but a terpineol solvent was used.

(Production of Bonding Article)

As an electrical insulating substrate, a soda-lime glass substrate (thickness of 0.3 mm, linear expansion coefficient of 88×10⁻⁷/° C.) was prepared. The following procedures were conducted for each prepared adhesion layer forming paste. First, the adhesion layer forming paste was applied to one surface of the soda-lime glass substrate by means of the screen printing technique and dried on a hot plate (at 150° C.) to form the lamination of 90 pieces of dry coating film (10 mm×10 mm each) for the second adhesion layer.

Next, the same adhesion layer forming paste was applied to the other surface of the soda-lime glass substrate by the same screen printing technique so that the paste will not be squeezed out from the contours when contours of the previously formed dry coating film were projected parallel to each other along the lamination direction, and then the substrate was dried on the hot plate (at 150° C.) to form the lamination of 90 pieces of dry coating film for the first adhesion layer. At this time, nine different sizes of dry coating film, ten pieces of each size, were prepared for the first adhesion layer. The coating film size were “9.8 mm×9.8 mm”, “9.6 mm×9.6 mm”, “9.4 mm×9.4 mm”, “9.2 mm×9.2 mm”, “9.0 mm×9.0 mm”, “8.5 mm×8.5 mm”, “8.0 mm×8.0 mm”, “7.0 mm×7.0 mm”, and “6.0 mm×6.0 mm”.

Subsequently, the soda-lime glass substrate in which dry coating films had been laminated on both surfaces was placed in an electric furnace, calcined in the atmosphere, and thus the dry coating films were baked onto the soda-lime glass substrate to form the first and second adhesion layers (average thickness of 25 μm each).

Specifically, with regard to specimens that use the low-melting-point lead-free glasses G-01 to G-10, the resin binder was pyrolyzed at 330° C. at the first-stage temperature rise, and then at the second-stage temperature rise, each specimen was calcined at a temperature 35° C. to 45° C. higher than the softening point Tₛ of the low-melting-point lead-free glass. With regard to specimens that use the low-melting-point lead-free glasses G-11 to G-20, the resin binder was pyrolyzed at 280° C. at the first-stage temperature rise, and then at the second-stage temperature rise, each specimen was calcined at a temperature 30° C. to 40° C. higher than the softening point Tₛ of the low-melting-point lead-free glass. With regard to specimens that use the low-melting-point lead-free glasses G-21 to G-37, the resin binder was pyrolyzed at 230° C. at the first-stage temperature rise, and then at the second-stage temperature rise, each specimen was calcined at a temperature 20° C. to 30° C. higher than the softening point Tₛ of the low-melting-point lead-free glass. With regard to specimens that use the low-melting-point lead-free glasses G-38 to G-42, the first-stage temperature rise was skipped because no resin binder was included, and then at the second-stage temperature rise, each specimen was calcined at a temperature 5° C. to 15° C. higher than the softening point Tₛ of the low-melting-point lead-free glass.

Finally, the soda-lime glass substrate onto which the first and second adhesion layers had been baked was cut along the contour of the second adhesion layer (10 mm×10 mm). In this way, bonding articles as shown in FIG. 2 were produced.

### Experimental 4

(Production of Bonded Body Using Bonding Article)

A bonded body was produced by using a bonding article prepared in experimental 3. For members to be joined used in this experiment, two Al blocks (JIS A 1100, 10 mm×10 mm×3 mm, and 15 mm×15 mm×3 mm) were prepared.

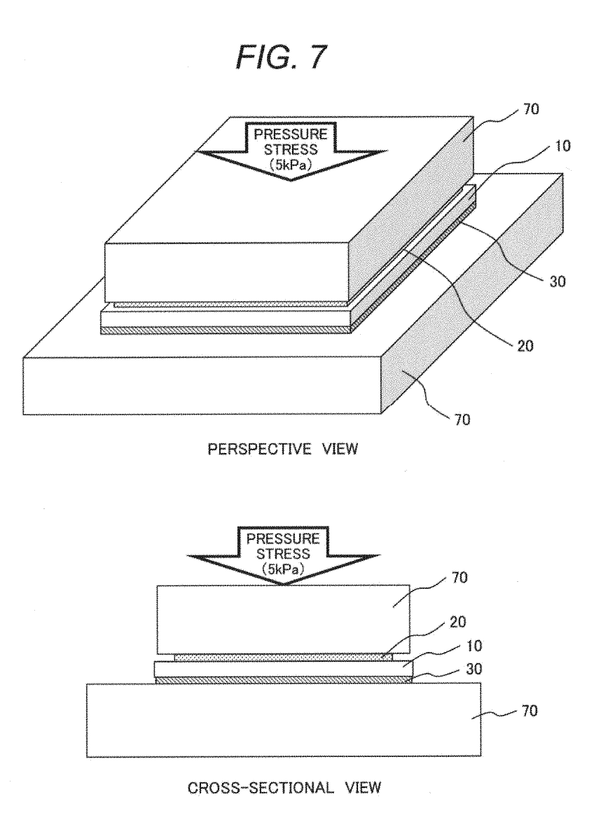

FIG. 7 is schematic illustrations showing a perspective view and a cross-sectional view of an exemplary process to bond members to be joined by using a bonding article according to the invention. As shown in FIG. 7, a bonded body 700 was produced in such a way that a bonding article 200 was interposed between two members 70 to be joined and then calcined at a temperature at which the first adhesion layer 20 and the second adhesion layer 30 soften and fluidize, while a pressure stress of 5 kPa was applied. The calcination temperature was 10° C. to 50° C. higher than the softening point Tₛ of the low-melting-point lead-free glass included in the first adhesion layer 20 and the second adhesion layer 30. After the calcination process had been finished, furnace cooling was conducted. Thus, nine kinds of bonded bodies were produced for five pieces each, with the size of the first adhesion layer 20 being different for each kind.

(Evaluation of Electrical Insulation Properties and Bonding Properties of Joint Portion)

The electrical insulation properties of the joint portions of the prepared bonded bodies 700 were evaluated. Specifically, by measuring the electrical resistivity between two members 70, a value of 1×10¹² Ωcm or more was judged to be electrically insulated, and a value of less than 1×10¹² Ωcm was judged not to be sufficiently electrically insulated. When all of five bonded bodies were judged to be electrically insulated, the evaluation result was determined to be “Passed”, and when one or more bonded bodies were judged not to be sufficiently electrically insulated, the evaluation result was determined to be “Failed”.

Furthermore, with regard to the bonded bodies determined to be “Passed”, the condition of the bonding between two members 70 (i.e., tilt or position gap of the bonded members 70) was visually checked. When the tilt or position gap of the bonded members 70 were not detected in all of the five bonded bodies, the evaluation result was determined to be “Excellent”; however, when the tilt or position gap of the bonded members 70 was detected in one or more bonded bodies, the evaluation result remained “Passed”. The evaluation results of electrical insulation properties and bonding properties are shown in Tables 6 and 7 along with the bonding article specifications.

TABLE 6
Specifications of bonding articles (B-01 to B-20), and evaluation results of
electrical insulation properties and bonding properties in joint portions of bonded bodies.

| | | | | | Evaluation results of electrical insulation properties and bonding properties | | | | | | | |
|---|---|---|---|---|---|---|---|---|---|---|---|---|
| | | | | | in joint portion of bonded body | | | | | | | |
| | | Filler | | Bonding | 9.8 × | 9.6 × | 9.4 × | 9.2 × | 9.0 × | 8.0 × | 7.0 × | 6.0 × |
| Bonding | | | Parts by | temperature | 9.8 mm² | 9.6 mm² | 9.4 mm² | 9.2 mm² | 9.0 mm² | 8.0 mm² | 7.0 mm² | 6.0 mm² |
| article No. | Glass No. | No. | volume | (° C.) | 96.4% | 92.3% | 88.4% | 84.6% | 81.0% | 64.0% | 49.0% | 36.0% |
| B-01 | G-01 | F-06 | 30 | 400 | Failed | Excellent | Excellent | Excellent | Excellent | Excellent | Passed | Failed |
| B-02 | G-02 | F-01 | 10 | 370 | Failed | Excellent | Excellent | Excellent | Excellent | Excellent | Passed | Failed |
| B-03 | G-03 | None | | 400 | Failed | Excellent | Excellent | Excellent | Excellent | Excellent | Passed | Failed |
| B-04 | G-04 | F-01 | 20 | 370 | Failed | Excellent | Excellent | Excellent | Excellent | Excellent | Passed | Failed |
| B-05 | G-05 | F-03 | 20 | 370 | Failed | Excellent | Excellent | Excellent | Excellent | Excellent | Passed | Failed |
| B-06 | G-06 | F-02 | 20 | 390 | Failed | Excellent | Excellent | Excellent | Excellent | Excellent | Passed | Failed |
| B-07 | G-07 | F-05 | 30 | 400 | Failed | Excellent | Excellent | Excellent | Excellent | Excellent | Passed | Failed |
| B-08 | G-08 | F-06 | 30 | 390 | Failed | Excellent | Excellent | Excellent | Excellent | Excellent | Passed | Failed |
| B-09 | G-09 | F-04 | 20 | 370 | Failed | Excellent | Excellent | Excellent | Excellent | Excellent | Passed | Failed |
| B-10 | G-10 | F-02 | 10 | 370 | Failed | Excellent | Excellent | Excellent | Excellent | Excellent | Passed | Failed |
| B-11 | G-11 | None | | 350 | Failed | Excellent | Excellent | Excellent | Excellent | Excellent | Passed | Failed |
| B-12 | G-12 | None | | 320 | Failed | Excellent | Excellent | Excellent | Excellent | Excellent | Passed | Failed |
| B-13 | G-13 | None | | 350 | Failed | Excellent | Excellent | Excellent | Excellent | Excellent | Passed | Failed |
| B-14 | G-14 | F-04 | 20 | 340 | Failed | Excellent | Excellent | Excellent | Excellent | Excellent | Passed | Failed |
| B-15 | G-15 | F-02 | 20 | 330 | Failed | Excellent | Excellent | Excellent | Excellent | Excellent | Passed | Failed |
| B-16 | G-16 | F-01 | 20 | 340 | Failed | Excellent | Excellent | Excellent | Excellent | Excellent | Passed | Failed |
| B-17 | G-17 | F-03 | 20 | 340 | Failed | Excellent | Excellent | Excellent | Excellent | Excellent | Passed | Failed |
| B-18 | G-18 | F-01 | 20 | 350 | Failed | Excellent | Excellent | Excellent | Excellent | Excellent | Passed | Failed |
| B-19 | G-19 | F-01 | 20 | 320 | Failed | Excellent | Excellent | Excellent | Excellent | Excellent | Passed | Failed |
| B-20 | G-20 | F-04 | 40 | 320 | Failed | Excellent | Excellent | Excellent | Excellent | Excellent | Passed | Failed |

TABLE 7
Specifications of bonding articles (B-21 to B-42), and evaluation results of
electrical insulation properties and bonding properties in joint portions of bonded bodies.

| | | | | | Evaluation results of electrical insulation properties and bonding properties | | | | | | | |
|---|---|---|---|---|---|---|---|---|---|---|---|---|
| | | | | | in joint portion of bonded body | | | | | | | |
| | | Filler | | Bonding | 9.8 × | 9.6 × | 9.4 × | 9.2 × | 9.0 × | 8.0 × | 7.0 × | 6.0 × |
| Bonding | | | Parts by | temperature | 9.8 mm² | 9.6 mm² | 9.4 mm² | 9.2 mm² | 9.0 mm² | 8.0 mm² | 7.0 mm² | 6.0 mm² |
| article No. | Glass No. | No. | volume | (° C.) | 96.4% | 92.3% | 88.4% | 84.6% | 81.0% | 64.0% | 49.0% | 36.0% |
| B-21 | G-21 | F-01 | 20 | 290 | Failed | Excellent | Excellent | Excellent | Excellent | Excellent | Passed | Failed |
| B-22 | G-22 | F-01 | 25 | 270 | Failed | Excellent | Excellent | Excellent | Excellent | Excellent | Passed | Failed |
| B-23 | G-23 | F-01 | 30 | 270 | Failed | Excellent | Excellent | Excellent | Excellent | Excellent | Passed | Failed |
| B-24 | G-24 | F-01 | 20 | 280 | Failed | Excellent | Excellent | Excellent | Excellent | Excellent | Passed | Failed |
| B-25 | G-25 | F-01 | 20 | 300 | Failed | Excellent | Excellent | Excellent | Excellent | Excellent | Passed | Failed |
| B-26 | G-26 | F-01 | 25 | 280 | Failed | Excellent | Excellent | Excellent | Excellent | Excellent | Passed | Failed |
| B-27 | G-27 | F-01 | 20 | 300 | Failed | Excellent | Excellent | Excellent | Excellent | Excellent | Passed | Failed |
| B-28 | G-28 | F-01 | 25 | 290 | Failed | Excellent | Excellent | Excellent | Excellent | Excellent | Passed | Failed |
| B-29 | G-29 | F-01 | 30 | 280 | Failed | Excellent | Excellent | Excellent | Excellent | Excellent | Passed | Failed |
| B-30 | G-30 | F-01 | 30 | 280 | Failed | Excellent | Excellent | Excellent | Excellent | Excellent | Passed | Failed |
| B-31 | G-31 | F-01 | 20 | 290 | Failed | Excellent | Excellent | Excellent | Excellent | Excellent | Passed | Failed |
| B-32 | G-32 | F-01 | 20 | 300 | Failed | Excellent | Excellent | Excellent | Excellent | Excellent | Passed | Failed |
| B-33 | G-33 | F-02 | 30 | 310 | Failed | Excellent | Excellent | Excellent | Excellent | Excellent | Passed | Failed |
| B-34 | G-34 | F-02 | 30 | 310 | Failed | Excellent | Excellent | Excellent | Excellent | Excellent | Passed | Failed |
| B-35 | G-35 | F-02 | 30 | 310 | Failed | Excellent | Excellent | Excellent | Excellent | Excellent | Passed | Failed |
| B-36 | G-36 | F-02 | 30 | 310 | Failed | Excellent | Excellent | Excellent | Excellent | Excellent | Passed | Failed |
| B-37 | G-37 | F-01 | 20 | 310 | Failed | Excellent | Excellent | Excellent | Excellent | Excellent | Passed | Failed |
| B-38 | G-38 | F-01 | 40 | 220 | Failed | Excellent | Excellent | Excellent | Excellent | Excellent | Passed | Failed |
| B-39 | G-39 | F-01 | 35 | 220 | Failed | Excellent | Excellent | Excellent | Excellent | Excellent | Passed | Failed |
| B-40 | G-40 | F-01 | 35 | 210 | Failed | Excellent | Excellent | Excellent | Excellent | Excellent | Passed | Failed |
| B-41 | G-41 | F-01 | 40 | 200 | Failed | Excellent | Excellent | Excellent | Excellent | Excellent | Passed | Failed |
| B-42 | G-42 | F-01 | 40 | 200 | Failed | Excellent | Excellent | Excellent | Excellent | Excellent | Passed | Failed |

As shown in Tables 6 and 7, all of the bonding articles have similar evaluation results. Specifically, as for the bonding articles having a “9.8 mm×9.8 mm” first adhesion layer ((area of bonding surface of first adhesion layer)/(area of bonding surface of second adhesion layer)=96.4%), the electrical insulation properties are “Failed”. It is considered that this is because the difference between the area of the bonding surface of the first adhesion layer 20 and the area of the bonding surface of the second adhesion layer 30 is too small, which causes an electric short circuit between the first adhesion layer 20 and the second adhesion layer 30 at the outer edge of the soda-lime glass substrate.

In contrast, as for the bonding articles from those having a “9.6 mm×9.6 mm” first adhesion layer ((area of bonding surface of first adhesion layer)/(area of bonding surface of second adhesion layer)=92.3%) to those having a “8.0 mm×8.0 mm” first adhesion layer ((area of bonding surface of first adhesion layer)/(area of bonding surface of second adhesion layer)=64.0%), the electrical insulation properties and the bonding properties are “Excellent”. Furthermore, as for the bonding articles having a “7.0 mm×7.0 mm” first adhesion layer ((area of bonding surface of first adhesion layer)/(area of bonding surface of second adhesion layer)=49.0%), the electrical insulation properties is “Passed”. This is considered because an electric short circuit between the first adhesion layer 20 and the second adhesion layer 30 at the outer edge of the soda-lime glass substrate is successfully prevented.

On the other hand, as for the bonding articles having a “6.0 mm×6.0 mm” first adhesion layer ((area of bonding surface of first adhesion layer)/(area of bonding surface of second adhesion layer)=36.0%), the electrical insulation properties are “Failed”. As the result of close observation of the bonding condition, it was found that cracks were present on the soda-lime glass substrate as an electrical insulating substrate 10. This is considered because the area of the bonding surface of the first adhesion layer 20 is too small, which causes the bonded member 70 to tilt further and incorrectly be positioned, damaging the soda-lime glass substrate; and because of the resulting cracks, an electric short circuit occurs between the first adhesion layer 20 and the second adhesion layer 30.

Based on the above, it is verified that the area of the bonding surface of the first adhesion layer 20 preferably be within a range from 49% to 95% of the area of the bonding surface of the second adhesion layer 30; and more preferably within a range from 64% to 93%. Furthermore, it is verified that the filler particles mixed into the first adhesion layer 20 and the second adhesion layer 30 are not particularly limited, and conventional filler particles made of ceramics or metals can be used appropriately.

### Experimental 5

(Production of Adhesion Layer Forming Paste)

Adhesion layer forming pastes were produced by using powders of the low-melting-point lead-free glasses G-08 and G-09, filler particles F-01, an ethyl cellulose resin binder, and a butyl carbitol acetate solvent. The blend ratio of the low-melting-point lead-free glass powder and the filler particles was determined by taking into consideration the linear expansion coefficient of the electrical insulating substrate and members to be joined, described later. Specifically, the blend ratio of the adhesion layer forming paste for the first adhesion layer was 65 volume % of G-08 and 35 volume % of F-01. The blend ratio of the adhesion layer forming paste for the second adhesion layer was 70 volume % of G-09 and 30 volume % of F-01.

(Production of Bonding Article)

A borosilicate glass substrate (thickness of 0.1 mm, linear expansion coefficient of 58×10⁻⁷/° C.) was prepared to be used for an electrical insulating substrate. According to the same procedures as experimental 3, 70 pieces of dry coating film for the second adhesion layer (6.0 mm×6.0 mm each) were laminated on one surface of the borosilicate glass substrate; and then 70 pieces of dry coating film for the first adhesion layer (5.5 mm×5.5 mm each) were laminated on the other surface of the borosilicate glass substrate. That is, (area of bonding surface of first adhesion layer)/(area of bonding surface of second adhesion layer) is 84.0%.

In order to adjust the average thickness of the first adhesion layer and the second adhesion layer of the final bonding article when forming dry coating film, seven different kinds of dry coating film each having a different average thickness, ten pieces of each kind, were prepared by controlling the number of times at which the paste was applied and dried.

Next, the borosilicate glass substrate in which dry coating film had been laminated on both surfaces was placed in the electric furnace, calcined in the atmosphere, and then the dry coating films were baked onto the borosilicate glass substrate to form a first adhesion layer and a second adhesion layer. Finally, the borosilicate glass substrate onto which the first adhesion layer and the second adhesion layer had been baked was cut along the contour of the second adhesion layer (6.0 mm×6.0 mm); thus, bonding articles as shown in FIG. 2 were produced. Seven kinds of average thickness of the first adhesion layer and the second adhesion layer of the obtained bonding articles were 5 μm, 8 μm, 12 μm, 19 μm, 27 μm, 35 μm, and 43 μm.

(Production of Bonded Body Using Bonding Article)

Bonded bodies were produced by using prepared bonding articles. For members to be joined used in this experiment, a silicon (Si) chip in which Al film had been formed on the bonding surface (5 mm×5 mm×0.5 mm, linear expansion coefficient of 28×10⁻⁷/° C.) and an Fe-42Ni-6Cr alloy block (10 mm×10 mm×5 mm, linear expansion coefficient of 91×10⁻⁷/° C.) were prepared.

According to the same procedures as experimental 4, seven different kinds of bonded bodies, ten pieces of each kind, were produced in such a way that a bonding article was interposed between the Si chip and the alloy block (disposing the first adhesion layer 20 on a side of the Si chip and disposing the second adhesion layer 30 on a side of the alloy block) and calcined at a temperature (390° C.) at which the first adhesion layer 20 and the second adhesion layer 30 soften and fluidize, while a pressure stress of 26 kPa was applied.

(Evaluation of Electrical Insulation Properties and Bonding Durability of Joint Portion)

According to the same procedures as experimental 4, five pieces out of ten pieces each of seven kinds of bonded bodies were evaluated for the electrical insulation properties of the joint portions. When all of five bonded bodies were judged to be electrically insulated (1×10¹² Ωcm or more), the evaluation result was “Passed”, and when one or more bonded bodies were judged not to be sufficiently electrically insulated (less than 1×10¹² Ωcm), the evaluation result was “Failed”.

For each remaining five pieces out of seven kinds of bonded bodies, a temperature cycle test was performed and the bonding durability was evaluated. Specifically, a temperature cycle from −50° C. to +150° C. was performed, and the presence of peeling in the joint portion after 100 cycles, 500 cycles, and 1000 cycles was visually checked. When peeling in the joint portion was detected after 100 cycles, the evaluation result was “Failed”; when peeling in the joint portion was detected in one or no piece out of five pieces after 500 cycles, the evaluation result was “Passed”; and when peeling in the joint portion was detected in one or no piece out of five pieces after 1000 cycles, the evaluation result was “Excellent”. The evaluation results of the electrical insulation properties and the bonding durability are shown in Table 8.

TABLE 8
Specifications of bonding articles (B-43 to B-49), and evaluation
results of electrical insulation properties and bonding
durability in joint portions of bonded bodies.

| | Average thickness of first | Electrical | |
|---|---|---|---|
| Bonding | adhesion layer and second | insulation | Bonding |
| article No. | adhesion layer (μm) | properties | durability |
| B-43 | 5 | Passed | Failed |
| B-44 | 8 | Passed | Passed |
| B-45 | 12 | Passed | Excellent |
| B-46 | 19 | Passed | Excellent |
| B-47 | 27 | Passed | Excellent |
| B-48 | 35 | Passed | Passed |
| B-49 | 43 | Failed | Failed |

As shown in Table 8, the bonding articles B-43 to B-48 are judged to be “Passed” for their electrical insulation properties; however, the bonding article B-49 is judged to be “Failed” for its electrical insulation properties. In the bonding article B-49, the amounts of first adhesion layer 20 and second adhesion layer 30 were too much, and when the members to be joined were pressurized to bond to each other, excessive amounts of the first adhesion layer 20 and the second adhesion layer 30 were squeezed out, causing an electric short circuit to occur at the outer edge of the borosilicate glass substrate.

On the other hand, regarding the bonding durability, the bonding articles B-44 and B-48 are judged to be “Passed” and the bonding articles B-45 to B-47 are judged to be “Excellent”. In contrast, the bonding articles B-43 and B-49 are judged to be “Failed”. Because the amounts of first adhesion layer 20 and second adhesion layer 30 of the bonding article B-43 were not enough, the adhesion properties were considered insufficient. Because the amounts of first adhesion layer 20 and second adhesion layer 30 of the bonding article B-49 were too much, thermal stress resulting from the difference of the linear expansion coefficients was considered not to be sufficiently buffered.

Based on the above, it is verified that the average thickness of the first adhesion layer 20 and the second adhesion layer 30 is preferably within a range from 7 μm to 40 μm each; more preferably within a range from 8 μm to 35 μm each; and further preferably within a range from 10 μm to 30 μm each.

### Experimental 6

(Production of Adhesion Layer Forming Paste)

Adhesion layer forming pastes were produced by using powders of the low-melting-point lead-free glasses G-13 and G-18, filler particles F-01 and F-03, an aliphatic polycarbonate resin binder, and a propylene carbonate solvent. Specifically, the blend ratio of the low-melting-point lead-free glass powder and the filler particles for the adhesion layer forming paste for the first adhesion layer was 57 volume % of G-13 and 43 volume % of F-01. The blend ratio of the low-melting-point lead-free glass powder and the filler particles for the adhesion layer forming paste for the second adhesion layer was 85 volume % of G-18 and 15 volume % of F-03.

(Production of Bonding Article)

To be used for the electrical insulating substrates, polyimide resin films having three different thickness (thickness of 0.02 mm, 0.05 mm, 0.1 mm; linear expansion coefficient of 250×10⁻⁷/° C.) were prepared. According to the same procedures as experimental 3, 20 pieces of dry coating film for the second adhesion layer (diameter of 7.8 mm each) were laminated on one surface of each polyimide resin film, and then 20 pieces of dry coating film for the first adhesion layer (diameter of 6.8 mm each) were laminated on the other surface of the polyimide resin film. That is, (area of bonding surface of first adhesion layer)/(area of bonding surface of second adhesion layer) is 76.0%.

Next, the three kinds of polyimide resin films in which dry coating films had been laminated on both surfaces were placed in the electric furnace, calcined in the atmosphere at 345° C., and the dry coating films were baked onto each polyimide resin film to form a first adhesion layer and a second adhesion layer. Finally, the polyimide resin films onto which the first adhesion layer and the second adhesion layer had been baked were cut along the contour of the second adhesion layer (diameter of 7.8 mm); thus, three kinds of bonding articles as shown in FIG. 1 were produced. The average thickness of the first and second adhesion layers of the obtained bonding article was 25 μm each.

(Production of Bonded Body Using Bonding Article)

Bonded bodies were prepared by using the prepared three kinds of bonding articles. For members to be joined used in this experiment, a silicon carbide (SiC) chip (4.5 mm×4.5 mm×0.5 mm, linear expansion coefficient of 35×10⁻⁷/° C.) in which Al film had been formed on the bonding surface and an Al block (JIS A 1100, diameter of 10 mm×height of 5 mm, linear expansion coefficient of 224×10⁻⁷/° C.) were prepared.

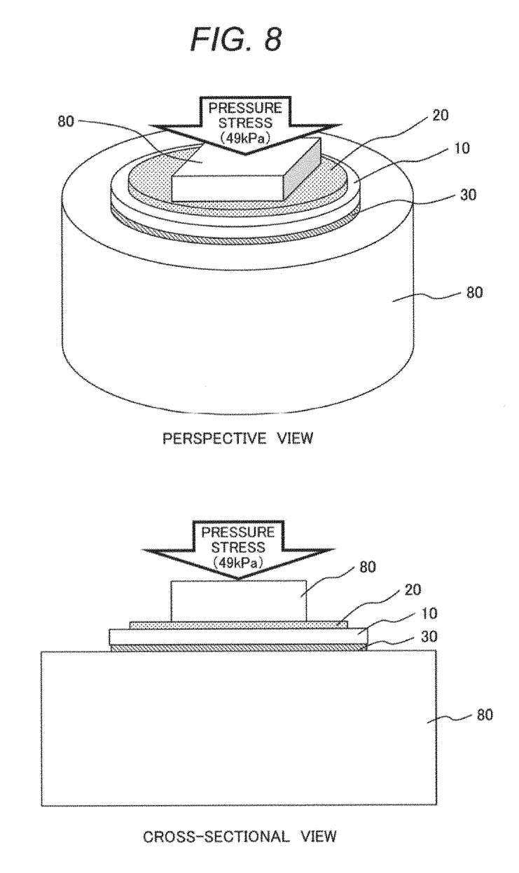

FIG. 8 is schematic illustrations showing a perspective view and a cross-sectional view of another exemplary process to bond members to be joined by using a bonding article according to the invention. As shown in FIG. 8, a bonded body 800 was produced in such a way that a bonding article 100 was interposed between two members 80 to be joined and then calcined at a temperature at which the first adhesion layer 20 and the second adhesion layer 30 soften and fluidize, while a pressure stress of 49 kPa was applied. The calcination temperature was 345° C.; and after the calcination process had been finished, furnace cooling was conducted. Thus, three different kinds of bonded bodies in which thickness of the polyimide resin film was different, twenty pieces of each kind, were produced.

(Evaluation of Production Yield of Bonded Bodies)

In this experiment, the production yield of the prepared three kinds of bonded bodies, twenty pieces of each kind, was evaluated because linear expansion coefficients of the members to be joined were significantly different from each other. Specifically, the presence of damage to the polyimide resin film and the presence of peeling in the joint portion were visually checked. As a result, damage to the polyimide resin film and peeling in the joint portion were not detected in all of the bonded bodies. This means that the production yield of the bonded bodies was 100%.

In other words, it is verified that by using an electrical insulating substrate made of polyimide resin film to bond members to be joined having significant different linear expansion coefficients as shown in this experiment, it is possible to obtain a bonded body at a high production yield, without particularly limiting the thickness of the electrical insulating substrate. It is also verified that the low-melting-point lead-free glasses used in the invention have high adhesion properties to a resin film such as a polyimide resin film.

(Evaluation of Electrical Insulation Properties and Bonding Durability of Joint Portion)

According to the same procedures as experimental 4, the electrical insulation properties of the joint portions were evaluated with regard to ten pieces out of twenty bonded bodies each of the three kinds of bonded bodies. When all of ten bonded bodies were judged to be electrically insulated (1×10¹² Ωcm or more), the evaluation result was “Passed”, and when one or more bonded bodies were judged not to be sufficiently electrically insulated (less than 1×10¹² Ωcm), the evaluation result was “Failed”.

For the remaining ten pieces each of three kinds of bonded bodies, the bonding durability was evaluated according to the same procedures as experimental 5. When peeling in the joint portion was detected after 100 cycles, the evaluation result was “Failed”; when peeling in the joint portion was detected in two pieces or less out of ten pieces after 500 cycles, the evaluation result was “Passed”; and when peeling in the joint portion was detected in two pieces or less out of ten pieces after 1000 cycles, the evaluation result was “Excellent”. The evaluation results of the electrical insulation properties and the bonding durability are shown in Table 9 along with the bonding article specifications.

TABLE 9
Specifications of bonding articles (B-50 to B-52), and evaluation results of
electrical insulation properties and bonding durability in joint portions of bonded bodies.

| Bonding article | | | | | | | | | |
|---|---|---|---|---|---|---|---|---|---|
| | Electrical insulating | | First adhesion layer | | Second adhesion layer | | | Bonding article | |
| | substrate | | | Filler | | Filler | Bonding | Electrical | |
| | | Thickness | Glass No. | particles No. | Glass No. | particles No. | temperature | insulation | Bonding |
| No. | Material | (mm) | (vol. %) | (vol. %) | (vol. %) | (vol. %) | (° C.) | properties | durability |
| B-50 | Polyimide | 0.02 | G-13 | F-01 | G-18 | F-03 | 345 | Passed | Excellent |
| B-51 | resin | 0.05 | (57%) | (43%) | (85%) | (15%) | | Passed | Excellent |
| B-52 | | 0.1 | | | | | | Passed | Excellent |

As shown in Table 9, as for the bonding articles B-50 to B-52, the electrical insulation properties are judged to be “Passed” and the bonding durability is judged to be “Excellent”. This means that it is verified that a bonding article using an electrical insulating substrate made of a polyimide resin film can achieve good electrical insulation properties and good bonding durability, without particularly limiting the thickness of the electrical insulating substrate.

### Experimental 7

(Production of Adhesion Layer Forming Paste)

Adhesion layer forming pastes were produced by using powders of the low-melting-point lead-free glasses G-11, G-13, G-19, G-20, G-25, G-27, G-35, G-37, G-38, and G-39, a filler particles F-01, an aliphatic polycarbonate resin binder, and butyl carbitol acetate and terpineol as solvents. The type of low-melting-point lead-free glass powder and the blend ratio of the low-melting-point lead-free glass powder and the filler particles were determined by taking into consideration the combination of the electrical insulating substrate and the members to be joined. Particular specifications will be shown later in Table 10.

(Production of Bonding Article)

As an electrical insulating substrate, a soda-lime glass substrate (thickness of 0.3 mm, linear expansion coefficient of 88×10⁻⁷/° C.) which was the same as that used in experimental 3, a borosilicate glass substrate (thickness of 0.1 mm, linear expansion coefficient of 58×10⁻⁷/° C.) which was the same as that used in experimental 5, and polyimide resin film (thickness of 0.05 mm, linear expansion coefficient of 250×10⁻⁷/° C.) which was the same as that used in experimental 6 were prepared. In addition to those, to adjust the linear expansion coefficient and stiffness of the electrical insulating substrate, resin films (altogether 7 kinds, each thickness of 0.5 mm) made by mixing a ceramic filler into polyimide resin, polyamide-imide resin, epoxy resin, phenoxy resin, and silicon resin were separately prepared. That is, altogether ten kinds of electrical insulating substrates (refer to Table 10) were prepared.

According to the same procedures as experimental 3, 20 pieces of dry coating film for the second adhesion layer (diameter of 8.2 mm each) were laminated on one surface of each of ten kinds of electrical insulating substrates, and then 20 pieces of dry coating film for the first adhesion layer (diameter of 7.3 mm each) were laminated on the other surface of each electrical insulating substrate. That is, (area of bonding surface of first adhesion layer)/(area of bonding surface of second adhesion layer) is 79.3%.

Next, ten kinds of electrical insulating substrates in which dry coating films had been laminated on both surfaces were placed in the electric furnace, calcined in the atmosphere at a temperature 10° C. to 30° C. higher than the softening point Tₛ of the low-melting-point lead-free glass, and then the dry coating films were baked onto the electrical insulating substrate to form a first adhesion layer and a second adhesion layer. Finally, the electrical insulating substrate onto which the first adhesion layer and the second adhesion layer had been baked was cut along the contour of the second adhesion layer (diameter of 8.2 mm); thus, ten kinds of bonding articles as shown in FIG. 1 were produced. The average thickness of the first and second adhesion layers of the obtained bonding article was 25 μm each.

(Preparation of Bonded Body Using Bonding Article) Bonded bodies were produced by using the prepared ten kinds of bonding articles. For members to be joined used in this experiment, an Si chip (5 mm×5 mm×0.5 mm, linear expansion coefficient of 28×10⁻⁷/° C.) in which Al film had been formed on the bonding surface and a stainless-steel block (SUS430, diameter of 10 mm×height of 3 mm, linear expansion coefficient of 110×10⁻⁷/° C.) were prepared.

According to the same procedures as experimental 6, ten kinds of bonded bodies, twenty pieces of each kind, were produced in such a way that a bonding article was interposed between the Si chip and the stainless-steel block (disposing the first adhesion layer 20 on a side of the Si chip and disposing the second adhesion layer 30 on a side of the stainless-steel block), and calcined at a temperature at which the first adhesion layer 20 and the second adhesion layer 30 soften and fluidize, while a pressure stress of 40 kPa was applied.

(Evaluation of Production Yield of Bonded Bodies)

According to the same procedures as experimental 6, the production yield of twenty pieces each of the prepared ten kinds of bonded bodies was evaluated. Specifically, the presence of damage to the electrical insulating substrate and the presence of peeling in the joint portion were visually checked. As a result, damage to the electrical insulating substrate and peeling in the joint were not detected in all bonded bodies. This means that the production yield of the bonded bodies was 100%.

(Evaluation of Electrical Insulation Properties and Bonding Durability of Joint Portion)

According to the same procedures as experimental 4, the electrical insulation properties of the joint portions were evaluated for ten pieces out of twenty bonded bodies each of ten kinds of bonded bodies. When all of ten bonded bodies were judged to be electrically insulated (1×10¹² Ωcm or more), the evaluation result was “Passed”, and when one or more bonded bodies were judged not to be sufficiently electrically insulated (less than 1×10¹² Ωcm), the evaluation result was “Failed”.

For the remaining ten pieces each of ten kinds of bonded bodies, the bonding durability was evaluated according to the same procedures as experimental 5. For the temperature cycle test to be performed in this experiment, the temperature range was from −50° C. to +100° C. When peeling in the joint portion was detected after 100 cycles, the evaluation result was “Failed”; when peeling in the joint portion was detected in two pieces or less out of ten pieces after 500 cycles, the evaluation result was “Passed”; and when peeling in the joint portion was detected in two pieces or less out of ten pieces after 1000 cycles, the assessment result was “Excellent”. The evaluation results of the electrical insulation properties and the bonding durability are shown in Table 10 along with the bonding article specifications.

TABLE 10
Specifications of bonding articles (B-53 to B-62), and evaluation results of
electrical insulation properties and bonding durability in joint portions of bonded bodies.

| Bonding article | | | | | | | | | |
|---|---|---|---|---|---|---|---|---|---|
| | Electrical | | First adhesion layer | | Second adhesion layer | | | Bonding article | |
| | insulating | | | Filler | | Filler | Bonding | Electrical | |
| | substrate | | Glass No. | particles No. | Glass No. | particles No. | temperature | insulation | Bonding |
| No. | Material | Filler | (vol. %) | (vol. %) | (vol. %) | (vol. %) | (° C.) | properties | durability |
| B-53 | Soda-lime | None | G-19 | F-01 | G-20 | F-01 | 310 | Passed | Excellent |
| | glass | | (55%) | (45%) | (60%) | (40%) | | | |
| B-54 | Borosilicate | None | G-11 | F-01 | G-13 | F-01 | 340 | Passed | Excellent |
| | glass | | (55%) | (45%) | (60%) | (40%) | | | |
| B-55 | Polyimide | None | G-35 | F-01 | G-37 | F-01 | 300 | Passed | Excellent |
| | resin | | (53%) | (47%) | (60%) | (40%) | | | |
| B-56 | Polyimide | F-02 | G-35 | F-01 | G-37 | F-01 | 300 | Passed | Excellent |
| B-57 | resin | F-03 | (53%) | (47%) | (60%) | (40%) | | Passed | Excellent |
| B-58 | Polyamide- | F-02 | G-25 | F-01 | G-27 | F-01 | 280 | Passed | Excellent |
| B-59 | imide | F-03 | (53%) | (47%) | (57%) | (43%) | | Passed | Excellent |
| | resin | | | | | | | | |
| B-60 | Epoxy | Glass | G-39 | F-01 | G-38 | F-01 | 220 | Passed | Excellent |
| | resin | cloth | (50%) | (50%) | (55%) | (45%) | | | |
| B-61 | Phenoxy | Glass | G-39 | F-01 | G-38 | F-01 | 220 | Passed | Excellent |
| | resin | cloth | (50%) | (50%) | (55%) | (45%) | | | |
| B-62 | Silicon | Glass | G-39 | F-01 | G-38 | F-01 | 220 | Passed | Excellent |
| | resin | cloth | (50%) | (50%) | (55%) | (45%) | | | |

As shown in Table 10, as for bonding articles B-53 to B-62, the electrical insulation properties are judged to be “Passed” and the bonding durability are judged to be “Excellent”. This means that it is verified that various kinds of electrical insulating substrates can be used for the bonding article according to the invention, and good electrical insulation properties and good bonding durability can be achieved.

As stated above, it is verified that the present invention can provide bonding articles suitable for low-temperature bonding of portions that require electrical insulation. Specifically, the bonding articles according to the invention can be preferably used for various electronic components (e.g., semiconductor sensors, MEMS devices, quartz crystal oscillators, and ultrasonic probes).

The above embodiments and experimentals are given for the purpose of detailed explanation only, and the invention is not intended to include all configurations of the specific examples described above. Also, a part of an embodiment may be replaced by known art, or added with known art. That is, a part of an embodiment of the invention may be combined with known art and modified based on known art without departing from the technical idea of the invention where appropriate.

1.-14. (canceled)

15. A bonding article, comprising:
an electrical insulating substrate;
a first adhesion layer laminated on a top surface of the electrical insulating substrate; and
a second adhesion layer laminated on a bottom surface of the electrical insulating substrate,
wherein each of the first adhesion layer and the second adhesion layer includes a low-melting-point lead-free glass containing vanadium oxide and tellurium oxide and having a softening point of 360° C. or lower, and
wherein an entire perimeter of the first adhesion layer is located inside a perimeter of the second adhesion layer in a plane parallel to the top surface of the electrical insulating substrate.

16. The bonding article according to claim 15, wherein
an area of a bonding surface of the first adhesion layer is between 49% to 95% of an area of a bonding surface of the second adhesion layer.

17. The bonding article according to claim 16, wherein
the area of the bonding surface of the first adhesion layer is between 64% to 93% of the area of the bonding surface of the second adhesion layer.

18. The bonding article according to claim 15, wherein
an average thickness of the first adhesion layer is between 7 μm and 40 μm.

19. The bonding article according to claim 15, wherein
an average thickness of the second adhesion layer is between 7 μm and 40 μm.

20. The bonding article according to claim 15, wherein
the perimeter of the second adhesion layer is located inside a perimeter of the electrical insulating substrate in the plane parallel to the top surface of the electrical insulating substrate.

21. A bonding article, comprising:
an electrical insulating substrate;
a first adhesion layer laminated on a top surface of the electrical insulating substrate; and
a second adhesion layer laminated on a bottom surface of the electrical insulating substrate,
wherein each of the first adhesion layer and the second adhesion layer includes a low-melting-point lead-free glass containing vanadium oxide and tellurium oxide and having a softening point of 360° C. or lower, and
wherein the first adhesion layer is divided into a plurality of first adhesion pads,
wherein an entire perimeter of each of said plurality of first adhesion pads is located inside a perimeter of the second adhesion layer in a plane parallel to the top surface of the electrical insulating substrate.

22. The bonding article according to claim 21,
wherein the second adhesion layer is divided into a plurality of second adhesion pads,
wherein an entire perimeter of each of said plurality of first adhesion pads is located inside a perimeter of one of said plurality of second adhesion pads in the plane parallel to the top surface of the electrical insulating substrate.

23. The bonding article according to claim 15, wherein
the low-melting-point lead-free glass further contains at least one of tungsten oxide, barium oxide, potassium oxide, and phosphorus oxide.

24. The bonding article according to claim 23, wherein
the low-melting-point lead-free glass further contains at least one of aluminum oxide, ferric oxide, yttrium oxide, and lanthanum oxide.

25. The bonding article according to claim 24, wherein
the low-melting-point lead-free glass further contains silver oxide.

26. The bonding article according to claim 15, wherein
at least one of the first adhesion layer and the second adhesion layer contains filler particles made of a ceramic or a metal.

27. The bonding article according to claim 15, wherein
the electrical insulating substrate is a resin substrate.

28. The bonding article according to claim 27, wherein
the resin substrate is made of a polyimide resin, a polyamide-imide resin, an epoxy resin, a phenoxy resin, or a silicon resin.

29. The bonding article according to claim 27, wherein
the electrical insulating substrate contains filler particles made of a ceramic.
